(19) United States
(12) Patent Application Publication
(10) Pub. No.: US 2008/0178202 A1
(43) Pub. Date: Jul. 24, 2008

(54) Interface For Supporting an Element Management System

(75) Inventors: David S. Blackman, Elkins Park, PA (US); James R. Burns, Hatfield, PA (US); Patrick J. Wright-Riley, Villanova, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/624,549

(22) Filed: Jan. 18, 2007

(51) Int. Cl. G06F 13/10

(52) U.S. Cl. 719/327

(57) ABSTRACT

Described herein are embodiments that provide a device model to the data structure, or management protocol, of an element management system (EMS) to support new and non-standard devices and incorporate such devices into the EMS for management of the devices. The device model employs device plug-ins for the EMS to gain access to the device without the need to make modifications in the EMS server core.

### BACKGROUND

Element Management Systems (EMS) are designed to manage and monitor devices (or elements) in a network and all of the device features using standard data structures or management protocols. One of the commonly used data structures (or protocols) is the Simple Network Management Protocol (SNMP). Although a SNMP data structure provides a standard format for passing and receiving configuration, health, and status data, to and from devices, its implementation by and for a given device can vary widely. When working within a family of devices, many of the Management Information Base (MIB) structures and characteristics used in the SNMP data structure are common, such as common identification, state, and trap MIBs. In a family of devices, there are also common mechanisms to maintain alarm state in the MIB, common coding of alarm/trap severities, common rules of configuration (e.g. number of dynamic tables, single save parameter), and common configuration file format. When working within these common guidelines for a family of devices, an EMS may be constructed to use a data-driven model to support the devices generically, whereby information in an EMS database is used to specify the set of configuration parameters, traps, and alarms for each device.

### BRIEF DESCRIPTION OF THE DRAWINGS

Embodiments are illustrated by way of example and not limited in the following figure(s), in which like numerals indicate like elements, in which:

FIG. 1 illustrates an object-oriented programming architecture of an EMS 100 that provides management of standard and non-standard devices;

FIG. 2 illustrates a device model class diagram;

FIG. 3 illustrates various plug-ins in a device model;

FIG. 4 illustrates a process for discovering a device at runtime;

FIG. 5 illustrates a process for constructing a device model at runtime to manage a device; and

FIG. 6 illustrates an exemplary block diagram of a computerized system 600 that is operable to be used to implement the EMS in FIG. 1 and methods in FIGS. 4 and 5.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

As an EMS begins to support additional standard and non-standard devices (e.g., those outside the original family of devices), relying on the aforementioned common guidelines for the underlying SNMP data structure becomes difficult if not impossible. This is because new devices are implemented in the SNMP data structure in different ways. Thus, limitations in the EMS design emerge. For example, non-standard devices may not use a common MIB, may have complex configuration rules that create conflicts among the devices, may not be captured in a data driven design, or may have traps and alarms that cannot be handled in a simple manner, e.g., by using the data driven design. Again, for example, some devices send traps that require an SNMP manager to retrieve additional information from the device in order to generate an event. As referred herein, and as understood in the art, a trap such as a SNMP trap is an unsolicited message from a managed device to an EMS notifying the happening of one or more particular or significant events at the managed device.

Described herein are methods and systems that address at least the aforementioned limitations in a conventional EMS design by providing mechanisms to allow custom object-oriented programming code to be “plugged in” (or dynamically loaded) to the EMS to handle both standard devices that are supported by the original EMS design and non-standard devices that are not supported by the original EMS design. Such mechanisms are also operable to support elements from various device vendors or manufacturers that do not standardize their SNMP MIB structures and have always required software development to integrate into an EMS. In the aforementioned cases, the plug-in mechanisms remove the conventional requirement of directly accessing the server core code of an EMS, which is time-consuming and may destabilize the EMS. Thus, when a new device is to be supported, a new plug-in of a defined format may be generated to interface to a defined API in the EMS without affecting the EMS server core code.

Accordingly, various embodiments herein provide a device model that is used by an EMS to provide device-specific features or functionalities for management of both a standard and non-standard device (hereinafter, “managed device”). The device model includes a set of device plug-in interfaces, based on object-oriented programming, that implements device-specific EMS functionalities for each device. Examples of device-specific EMS functionalities include but are not limited to fault-management (trap processing, alarm sync, and status polling), configuration, accounting, performance, and security (FCAPS) for the managed devices, or discovery of the devices to be managed. Thus, all device-specific code may reside in the device model while the EMS core code remains device independent.

Element Management System (EMS)

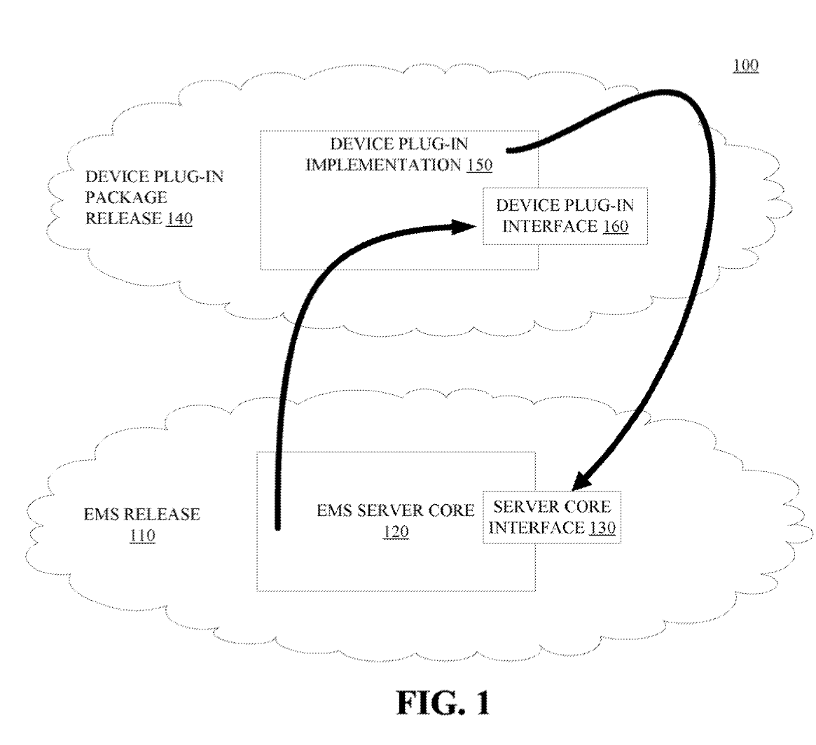

FIG. 1 illustrates an object-oriented programming architecture of an EMS 100 that provides management of standard and non-standard devices. The EMS 100 incorporates a device model therein to provide interfaces to standard and non-standard devices for accessing such devices to implement device-specific EMS functionalities, such as FCAPS functionalities. Thus, each managed device is represented in the device model as programming code, as implemented by a device plug-in package release 140. Each device plug-in package release 140 may be included in a firmware release of the managed device or in an EMS release (e.g., plug-ins to support legacy device). In one embodiment, the EMS 100 includes a plurality of device plug-in package releases 140, one for each device it manages. For example, for newly developed devices that are desired to be managed by the EMS 100, their plug-in Java class files are packaged into device plug-in releases 140 separately from the EMS 100 and version-delivered with device firmware releases for the newly developed devices. The device plug-in releases 140 are then delivered or loaded up to the EMS 100 for use to manage devices corresponding thereto. Each device plug-in release 140 includes at least one device plug-in implementation 150 and at least one device plug-in interface 160, as further described later.

Examples of managed devices include but are not limited to network devices and field devices. Network devices include but are not limited to network routers, network switches, network gateways, servers, and other devices that are used for networking purposes. Field devices include but are not limited to video headend devices or servers, uplink devices, field sensors for sensing any number of properties (e.g., data throughput, motion, temperature, power consumption), field actuators, power supplies, field controllers (e.g., programmable logic controllers), or any other devices that are operable for connection to an information technology (IT) network. As referred herein, and as understood in the art, information technology, or IT, encompasses all forms of technology, including but not limited to the design, development, installation, and implementation of hardware and software information systems and software applications, used to create, store, exchange and utilize information in its various forms including but not limited to business data, conversations, still images, motion pictures and multimedia presentations technology and with the design, development, installation, and implementation of information systems and applications.

The EMS 100 further includes an EMS server core 120 and a server core interface 130. The EMS server core 120 includes device-independent server core program code (hereinafter, “server core code”) that handles behaviors, operations, or processing steps (certain event handlings, library routines, server APIs, etc.) common to all devices. In one embodiment, the common-behavior operations resides in a TrapProcessor class of the server core code. The TrapProcessor class allows customization of each common-behavior operation or processing step. The server core interface 130 includes one or more interfaces, such as application programming interfaces (APIs), exported by the EMS server core 120 for use by a device plug-in implementation 150 for each managed device to access the aforementioned server core program code for operations common to all devices. Thus, the server core interface 130 is logically situated between each device plug-in implementation 150 and the EMS server core 120 to provide a unified server interface for the device plug-in implementations, such as the device plug-in implementation 150, to access the server core functionalities. It hides all server core code from the device plug-in implementations, so changes made to such a code have minimal impact on the device plug-in implementations, and vice versa. During implementation, the server core interface 130 is operable to directly call existing server APIs to implement those server core functionalities requested by the device plug-in implementations, such as the device plug-in implementation 150. In one embodiment, the server core interface 130 is versioned, whereby each new version is implemented with backward compatibility to earlier versions of both the server core interface 130 and the device plug-in implementation 150.

In one embodiment, the device plug-in implementation 150 is program code representing the proprietary specifications or properties of each managed device that the EMS 100 wishes to access for management customization, such as for implementing each one of the FCAPS functionalities. Thus, although FIG. 1 illustrates only one device plug-in implementation 150 in each device plug-in package release 140, it should be understood that the release 140 may include a plurality of device plug-in implementations 150. In an alternative embodiment, a single device plug-in implementation 150 for each managed device may be used for implementing a plurality or all of FCAPS functionalities and any other functionalities. A device plug-in implementation 150 for each managed device may be provided by the manufacturer of the managed device. The device plug-in implementation 150 is accessible by the EMS server core 120 through the device model and its device model class.

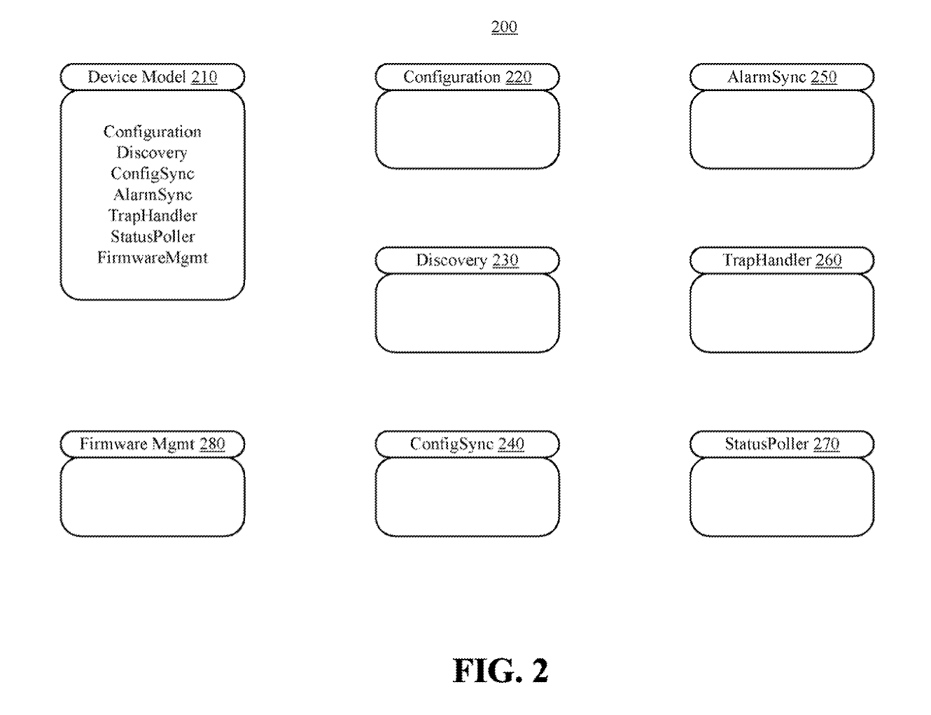

In one embodiment, the EMS 100 supports a device model class for each device model. Each device model class includes a collection of device plug-in interfaces that allow for customization of the device-specific EMS functionalities. For example, the interfaces for FCAPS functionalities include Configuration, Configuration Synchronization (ConfigSync), Discovery, Alarm Synchronization (AlarmSync), TrapProcessor, and StatusPoller device plug-in interfaces. The device model class is also operable to include interfaces that allow for customization of features other than FCAPS features. For example, a firmware management (FirmwareMgmt) device plug-in interface may be customized to facilitate changes to a device during firmware upgrades or downgrades. Thus, the device model class represents a generic device that is supported by the EMS 100 for management of such a device. FIG. 2 illustrates a device model class diagram 200. In the diagram 200, the device model class 210 includes multiple interfaces 220-280 as noted above. Each of these interfaces represents a device plug-in interface 160 illustrated in FIG. 1 that provides the server core 120 with access to the associated device plug-in implementation 150 for management customization of each managed device by the EMS 100, such as for implementation of one of the FCAPS functionalities. Thus, although FIG. 1 illustrates the release 140 having only one device plug-in interface 160 for a device plug-in implementation 150, it should be understood that the release 140 may include multiple device plug-in implementations 150, each with its own device plug-in interface 160.

As referred herein, a plug-in is a software program or programming code that interacts with a main application, such as the EMS, to provide one or more particular functions. As noted earlier, one or more plug-ins are included in each device plug-in package release 140, which may be included in an EMS release (e.g., a plug-in to support legacy devices) or in a firmware release for each managed device. For example, to implement all FCAPS functionalities the EMS 100 employs multiple device plug-in implementations 150 and multiple associated device plug-in interfaces 160 in a device model for the managed device. In one embodiment, as further described below, the EMS 100 allows specification of a package release 140 and plug-in(s) therein by device type, model, and firmware version. Alternative embodiments are contemplated, wherein the granularity may be less or more than device type, model, firmware version, as desired by the EMS user or administrator. For example, a TrapProcessor interface or plug-in, and the package release 140 for such an interface, may be specified by device type, model, firmware version and also trap type.

The aforementioned device model class is implemented by a device model implementation class, DeviceModelImpl, which provides the actual code that manages lookup/caching of plug-in classes and methods to get device identity information. Thus, the device model class and the DeviceModelImpl class include common methods to retrieve device identity information from, for example, a device index stored in the EMS database. Such methods may be used by various plug-in classes. As referred herein, a device index is a mapping or indexing of each device managed by the EMS 100 (e.g., as identified by an device identification or ID) to the corresponding device configurations particular to such a device that are stored in the EMS database. As also referred herein, a firmware map index is a mapping or indexing of each combination of device type, model, and firmware version to a corresponding package release 140 loaded up in the EMS 100. In some cases, firmware versions of different device types may share certain common behaviors or operations. In such cases, they also will share the same device plug-in(s). The device model class and the DeviceModelImpl class may be generated or created by a DeviceModelFactory class, which includes factory methods for loading plug-in classes (or plug-in implementations) based on the firmware map index or device index for, e.g., FCAPS subsystems, in order to generate the device model class and DeviceModelImpl class.

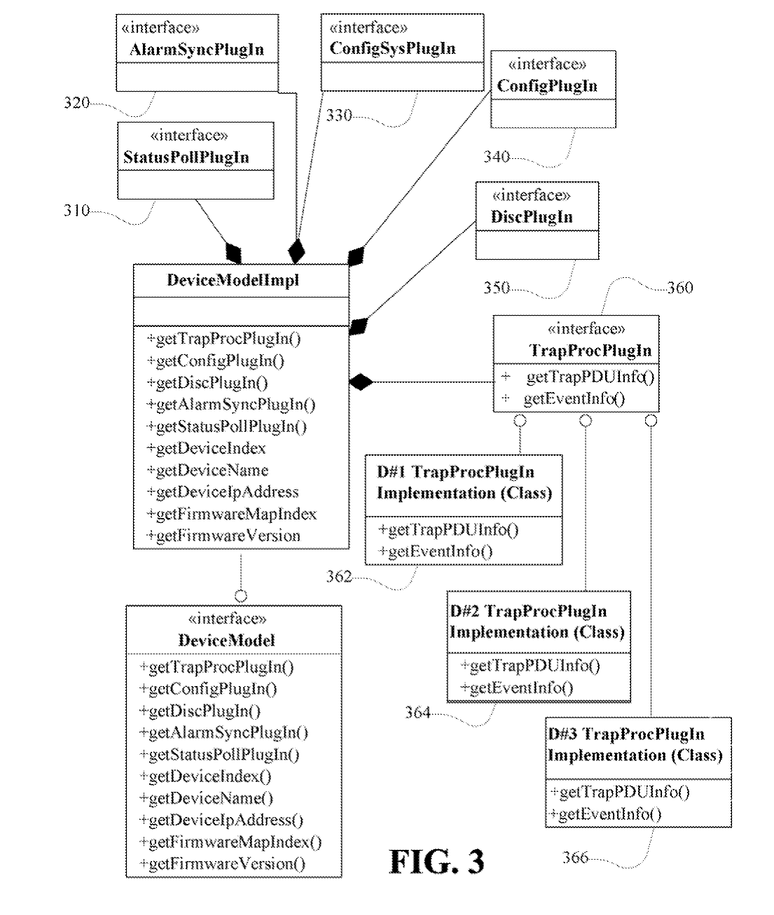

Accordingly, the device plug-in interface 160 is a plug-in interface that is extended to represent all plug-ins. It exposes methods common to all plug-ins. For example, FIG. 3 illustrates the aforementioned FCAPS interfaces Configuration, Configuration Synchronization (ConfigSync), Discovery, AlarmSync, TrapProcessor, and StatusPoller being implemented as ConfigPlugIn 340, ConfigSyncPlugIn 330, DiscPlugIn 350, AlarmSyncPlugIn 320, TrapProcPlugIn 360, and StatusPollPlugIn 310, respectively. These plug-ins are described below. For simplicity, only the TrapProcPlugIn subsystem with its trap processing plug-in classes are illustrated in FIG. 3. Other interface subsystems follow a similar concept.

In one embodiment, the ConfigSyncPlugIn provides an identification of the mode of each parameter in a managed device. This identification is important for proper EMS management of a device because device parameters may switch between configuration, status, and control modes without knowledge by the EMS 100.

In one embodiment, the TrapProcPlugIn 360 is an interface that is visible to the server core code, where it is called to access a corresponding device plug-in implementation 150 to perform device-specific operations with relative stability over the lifetime of the EMS 100. As such, this plug-in includes only relevant device-specific operations. For example, checking a trap receiving order is a device-specific behavior, however, some steps in this operation, such as retrieving and updating trap ordering information in the EMS database and performing alarm sync, are well-defined common behaviors so they are included in the server core code 120. In other words, only methods for getting the trap ordering information from a trap protocol data unit (PDU) in a device plug-in implementation 150 and comparing it with what is stored in the EMS database are device-specific and located in the TrapProcPlugIn 360, as represented by device plug-in interface 160 in FIG. 1. In turn, the TrapProcPlugIn interface 360 allows access to a corresponding device plug-in implementation 150 of a managed device, such as one of the device plug-in implementations 362, 364, and 366 for different devices to retrieve trap ordering information from a managed device and update such information in the EMS database. Some of the TrapProcPlugIns may be common across many device types. Some trap types in certain managed devices may have their own behaviors in gathering event information (e.g., require EMS 100 to retrieve additional information from the device via SNMP to generate the event). In such cases, a trap processing plug-in class is also dependent on the trap type. For example, the class 366 may inherit from several trap-type specific, trap processing plug-in classes. Because of this, all trap processing plug-in classes are associated with the firmware map index as well as a trap type.

In one embodiment, the StatusPollPlugIn is a plug-in interface that provides periodic health check of the managed device and determines whether the EMS database is still in synchronization with the managed device with regard to alarms and configurations of such a device.

In one embodiment, the AlarmSyncPlugIn is a plug-in interface that ensures that the EMS database with all the alarm information for the device is consistent with the device alarm state.

In one embodiment, the ConfigPlugIn is a plug-in interface that includes code to register handlers for all supported device configuration parameters, including identity parameters for each managed device, such as the device's IP address, MAC address, etc. Each device will have it in a different place. Thus, the ConfigPlugIn is operable to access a corresponding device plug-in implementation 150 to obtain such device configuration information from the managed device.

In one embodiment, the DiscPlugin provides methods to acquire the type, the model, and the firmware version of the device being discovered. If a discovery plug-in of a device is not capable of acquiring the model and firmware version, it is operable to return a failure indication to the EMS 100.

The aforementioned plug-ins are designed such that only a small set of the EMS server core functionalities are exposed through the EMS server core interface 130, and the EMS server core 120 remain relatively stable over the lifetime of the EMS 100. In one embodiment, the plug-ins only have knowledge of the device firmware it handles, while leaving all of the EMS server knowledge (such as EMS database access) to the server core code in the EMS server core 120. In a further embodiment, each of the plug-ins is implemented by a set of Java class files that are specified using certain formatted configuration files delivered with the firmware of the managed device 140. It should be understood that throughout the present disclosure the plug-ins, classes, and methods are named herein for identification purposes, and any other names may be used to identify the plug-ins, classes, methods described herein.

In one embodiment, there is provided a base implementation class for all plug-ins called the AbstractPlugin class. It provides access to a logger object (for logging within the plug-in) and a method to locate the server core interface 130. Thus, for example, the aforementioned FCAPS plug-ins implement the FCAPS interfaces and extend the AbstractPlugIn class.

In one embodiment, the object-oriented programming server core code in the EMS server core 120 manages a device by implementing a number of programming applications or modules for calling plug-ins 160 to access the specific functionalities of each managed device. For example, the server core code implements Configuration, ConfigSync, Discovery, AlarmSync, TrapProcessor, and StatusPoller modules to call up the ConfigPlugIn 340, ConfigSyncPlugIn 330, DiscPlugIn 350, AlarmSyncPlugIn 320, TrapProcPlugIn 360, and the StatusPollPlugIn 310 (FIG. 3), respectively, to access the device-specific FCAPS functionalities. The FCAPS modules are described below.

The Configuration module provides methods for calling the ConfigPlugIn to read or write a set of device configuration parameters from or to a single managed device and to configure trap receiver and addresses in the EMS 100. There are two types of device configuration parameters supported by the Configuration module: physical and virtual parameters. Physical parameters are those which are actually supported by the device. They generally appear in the device's MIB. Virtual parameters are processed by the EMS server core 120 and provide an abstraction layer over the physical parameters. Examples of virtual parameters are emsIdentDeviceIPAddress, emsIdentDeviceSubnetMask, emsIdentDeviceMACAddress, and emsIdentDeviceGateway. These virtual parameters provide an abstraction layer over the device-specific device configuration parameters representing a device's IP address, subnet mask, MAC address, and gateway, respectively. They allow a client, such as an EMS graphical user interface or GUI, to access a device's IP address without knowing the device's specific parameter for the IP address. This allows the EMS GUI to work for all device types without hard-coded knowledge of device-specific parameters. The handling of these parameters are done in a device plug-in called ConfigPlugIn for each managed device, which contains code for registering all parameter handlers to access the associated parameters in the managed device via a device plug-in implementation 150. The plug-in code is responsible for setting and getting the device configuration parameters from a corresponding device plug-in implementation 150 and converting data type of these parameters. For example, in addition to the four virtual parameters above, the following virtual parameters may be implemented: emsIdentSerialNumber, emsIdentModel, and emsIdentFirmwareVersion. These allow the EMS GUI to display the serial number, model, and firmware version, respectively, for devices which do not support certain identification MIB of certain predetermined devices. With the Configuration module, the EMS 100 is able to call up a device's ConfigPlugIn based on the device type, model, and firmware version, or any granularity as defined for each device plug-in package release 140 in which the ConfigPlugIn resides.

The ConfigSync module is responsible for retrieving all configuration parameters from the device and comparing them to the EMS database. It also sets or clears the parameters' discrepancy flags, which provide the EMS 100 and its operator with indications of which parameters in a managed device that have different values from those stored in the EMS database for the same device. For some devices, the set of device parameters is determined by the mode of the device, such as configuration, status, and control modes. Additionally, the ConfigSync module calls up the ConfigSysPlugIn to copy certain status parameters from the device to the EMS database which may change without the EMS's knowledge (e.g., serial number identifying the managed device,). The EMS 100 is capable of selecting a ConfigSync class for the ConfigSync module based on the device type, model, and firmware version.

The Discovery module is responsible for detecting and identifying device type/firmware/model, adding a newly discovered device to the EMS database and automatically assigning the newly discovered device to a management group based on the discovery mapping data entered by an EMS operator, retrieving and transferring all configuration data from the device to the EMS database, discovering entitlements granted to a device; enforcing any EMS device limit entitlement, selecting a StatusPoller class which dispatches to the device specific status poller, kicking off an initial status poll, adding performance polls; maintaining a rolled-up status indicating the success/failure of the discovery operation or any operations of the other modules in the server core code. In one embodiment, discovery of a network system or device for management is normally initiated by an EMS operator, with each network therein being periodically re-discovered by a network management system (NMS) engine. In one embodiment, the Discovery module is capable of selecting a discovery plug-in based on the device type, model, and/or firmware version (or any desired granularity). In another embodiment, the Discovery module provides the EMS 100 with a process or algorithm to find a discovery plug-in in the device plug-in interface 160 of a device being discovered. The process includes: determining the device type; iterating over all device plug-ins for such a device type, finding the highest firmware version of the discovery plug-in (in a corresponding device plug-in package release 140 for the highest firmware of the device) which can determine the device model and firmware; generating a discovery failure event if the model and firmware version cannot be determined by any plug-in; and using a predetermined EMS mapping algorithm to assign a firmware to a device.

The AlarmSync module synchronizes a device's alarm state with the alarms in the EMS database. It is invoked under the following conditions: initial device discovery, reception of an out of sequence trap, manual initiation by the operator, status poller detecting that EMS's trap last accepted doesn't agree with the device's trap last sent. The EMS 100 is capable of providing a core AlarmSync class which is responsible for carrying out the common processing steps required for this operation based on the device type, model firmware and parameter ID of each managed device. The core code then employs such an AlarmSync class to handle device-specific processing. The EMS 100 is capable of invoking the AlarmSync module to initiate the AlarmSync process asynchronously. The EMS 100 is also able to retrieve other data from a device to determine its alarm state. The EMS 100 also supports performing an AlarmSync of dynamic table, each table may require its own plug-in. The AlarmSync module is operable to issue a sequence of events to synchronize a device's alarm state and the EMS database, update the EMS database for a device on completion of the AlarmSync module, and perform predefined statistics collection.

The TrapProcessor module is responsible for implementing or carrying the common processing steps, that is, those operations that are common to all devices. The EMS 100 is capable of selecting a TrapProcessor class to handle a trap based on the device, type, model, firmware and trap type. As noted earlier, the TrapProcessor class is included in the EMS server core 120. The TrapProcessor class acts as the starting point of the EMS trap processing. This class performs two sets of trap processing operations: behaviors common to all devices and behaviors that are device specific. Common behavior operations belong in the server core code and reside directly in the TrapProcessor class, as noted earlier. Device-specific operations are carried out by the dynamically-loaded trap processing plug-in classes or implementations (e.g., classes or implementations 362, 364, and 366 in FIG. 3) based on the device firmware map index (and also based on trap type in the trap processing case, as noted earlier). These trap processing plug-in classes are obtained via the device model. The EMS 100 performs no processing except trap forwarding to one or more destinations for a trap if the device sending the trap is unmanaged. For devices that support trap sequence numbers, the EMS 100 maintains a ‘trapLastAccepted’ in the EMS database and compares the sequence number of the incoming trap to the EMS database. Traps out of sequence are discarded and triggers an Alarm Sync in the AlarmSync module. The EMS 100 is also capable of dropping traps based on criteria such as device, trap type, etc. and processing Configuration Changed Traps to avoid flagging a device as not capable for the ConfigSync module.

The StatusPoller module is periodically invoked by a NMS engine to determine the communication state of a device. The EMS is capable of: selecting a StatusPoller class based on the device type, model, and firmware version; polling only those devices that are being managed by the EMS 100 (unmanaged devices are not polled); maintaining the device's interface status as predefined; synchronizing alarms under the following conditions, 1) the device supports a trapLastSent and its sequence number does not match the sequence number of the last trap received by the EMS 100, and 2) the device does not send traps. The EMS 100 also updates the EMS database for a device on completion of a Status Poll and does not perform any status polls when the EMS 100 is operating in the maintenance mode.

Process

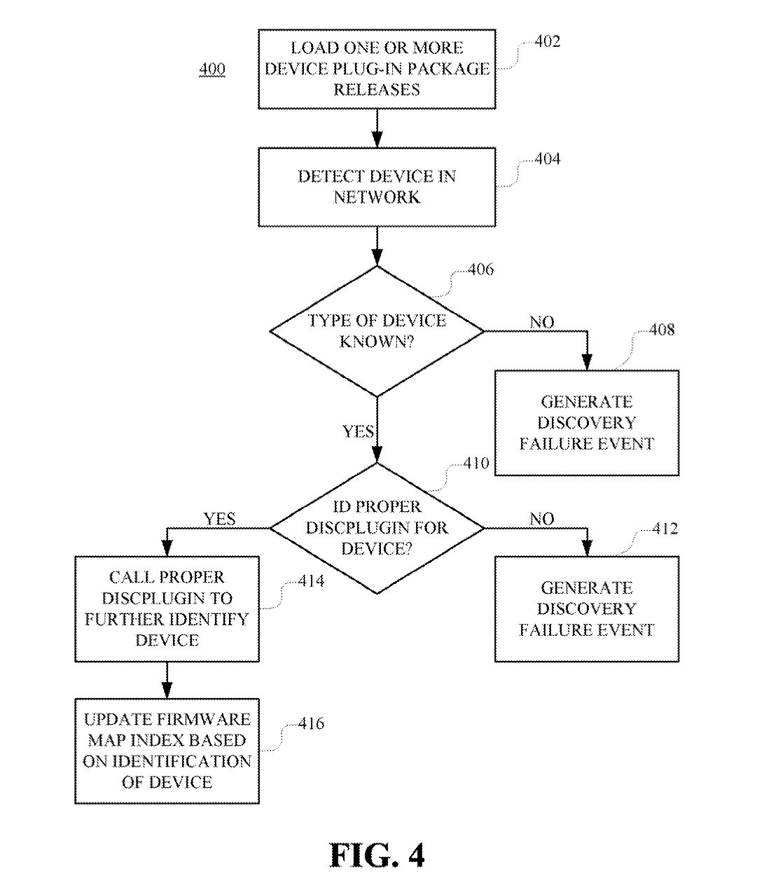

FIG. 4 illustrates a process 400 for the EMS 100 to discover at runtime a device to be managed by the EMS 100. For illustrative purposes only and not to be limiting thereof, the process flow 400 is discussed in the context of the EMS system 100 illustrated in FIGS. 1-3.

At 402, one or more device plug-in package releases 140 are loaded into the EMS 100. As described below, each release 140 is used to construct a device model for a particular device to be managed by the EMS 100, based on the device type, model, and firmware version used in such a device. The releases 140 are also indexed in a firmware map index or a device index in the EMS database, in accordance with the association of each release 140 to a particular device type, model, and firmware version. Although the device type, model, and firmware version are mentioned here, as noted earlier, the granularity specified for each release 140 may be set as desired.

At 404, the EMS 100 detects or discovers a device in a network of devices that is managed by the EMS 100. As noted earlier, this discovery is normally initiated by the an EMS operator, with the network periodically re-discovered by an NMS engine.

At 406, the EMS 100 attempts to identify or determine the type of the detected device. For example, a device may be detected at 404 by its sysObjectID. As understood in the art, the sysObjectID is a parameter in the MIB of a standard SNMP that specifies a vendor's identification of an equipment or device. This identification may include a type for the detected device. Thus, the server core code in the EMS 100 may identify the type of the detected device from the device's sysObjectID. In an alternative embodiment, the type of the device may be specified from a user input, for example, as entered by an EMS operator.

At 408, if the device type cannot be determined, the EMS 100 generates a discovery failure event. At this point, the EMS operator may wish to assign or create a particular device plug-in package release 140 for the detected device.

At 410, if the device type is known, the EMS server core code employs a Discovery module in its server core 120 to search through the loaded-up plurality of device plug-in package releases 140 for a proper discovery plug-in (DiscPlugIn) 160, and associated device plug-in implementation 150, that is capable of identifying the model and firmware version of the detected device.

At 412, if the model and firmware version cannot be determined by any of the Discovery plug-ins, the Discovery module also generates a discovery failure event for the EMS 100. At this point, the EMS operator may wish to assign or create a particular device plug-in package release 140 for the detected device.

At 414, however, if the model and firmware version can be determined by one of the DiscPlugIns, the Discovery module then calls on such a DiscPlugIn to further identify the model and firmware of the detected device. The EMS server core code may also update the firmware map index in the EMS database here. Thus, in the future, if a second device of the same type as the aforementioned first device is detected or discovered in the network, the same DiscPlugIn may be used to further identify the second device.

At 416, based on the determined type, model, and firmware version of the detected device, the EMS server core code searches the loaded-up plurality of device plug-in release packages 140 for one that may be employed to construct a device model for the detected device and updates the firmware map index in the EMS database to match or associate such a release package 140 with the determined device type, model and firmware version. Thus, in the future, if a second device of the same type, model, and firmware version as the aforementioned first device is further detected or discovered in the network, the same release package 140 associated with the first device is also associated with the second device to construct a device model for the second device.

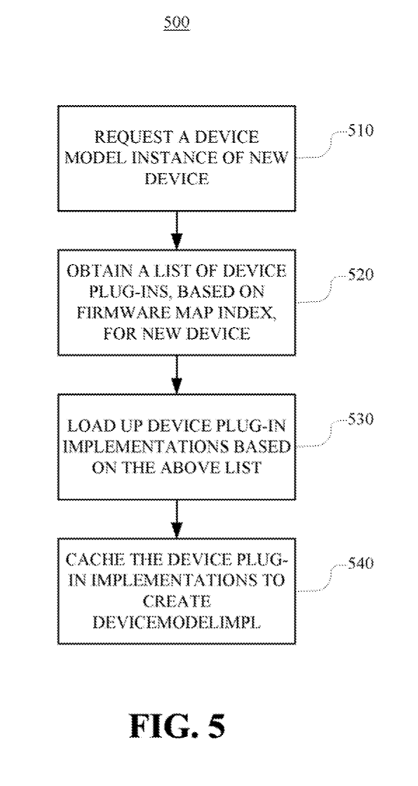

FIG. 5 illustrates a process 500 for the EMS 100 to construct at runtime a specific device model for a device to be managed, once such a device is discovered. For illustrative purposes only and not to be limiting thereof, the process flow 500 is discussed in the context of the EMS system 100 illustrated in FIGS. 1-3.

At 510, the server core code in the EMS server core 120 requests a handle on a device model instance for the detected device. In one embodiment, this is performed by the server core code first calling on the DeviceModelFactory class, which is also in the server core 120 and uses a singleton design pattern that is accessible or callable by a static getInstance method.

At 520, the DeviceModelFactory class employs one or more factory methods therein to obtain a list of device plug-ins 160 required for the proper device plug-in package release 140 discovered earlier for the detected device, as mapped by the firmware map index (see 416, FIG. 4).

At 530, the DeviceModelFactory class employs one or more additional factory-installed methods, such as a classloader method, therein to load up the device plug-in implementations 150 from the device plug-in package release 140 by calling on the device plug-ins 160 in the list.

At 540, the DeviceModelFactory class then caches the loaded device plug-in implementations 150 in the device model instance to create a DeviceModelImpl instance to implement the requested device model instance. The DeviceModelImpl instance is then returned by the DeviceModelFactory class for the EMS 100 to access one or more functionalities of the detected device to manage such a device. For example, the device plug-in implementations 150 may be for accessing and implementing FCAPS functionalities in the detected device, or discovery of the detected device to retrieve and transfer all configuration data from the detected device to the EMS database and to update the device index to correspond such a device to its device configuration data in the EMS database.

Accordingly, once there is provide a DeviceModelImpl instance, or device model implementation instance, the EMS 100 is able to manage the detected device via the device plug-ins 160 without the need to directly access the server core code in the server core 120, which is time consuming and may destabilizes the entire EMS 100.

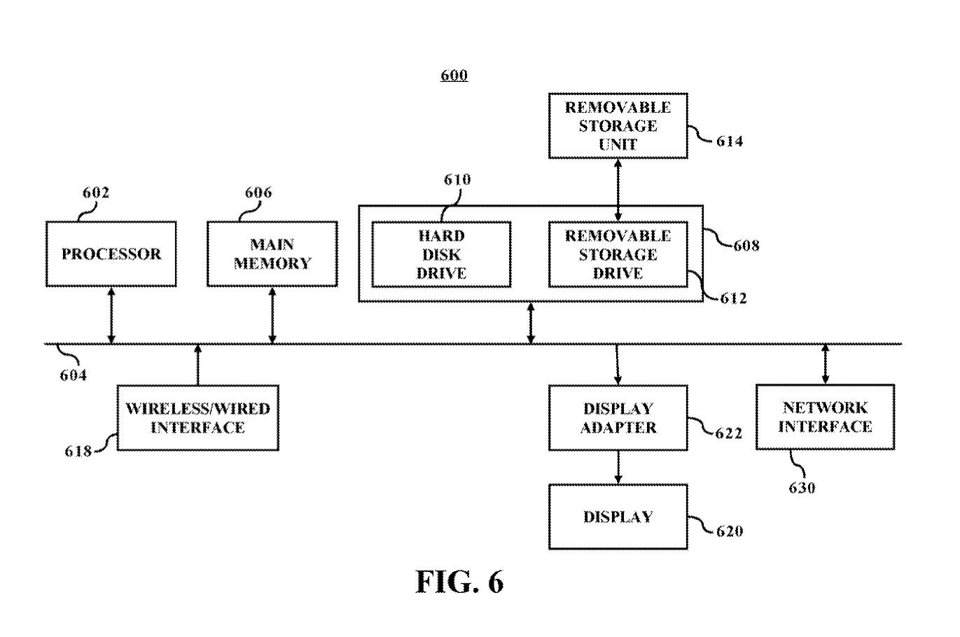

FIG. 6 illustrates an exemplary block diagram of a computerized system 600 that is operable to be used to implement the EMS 100 and aforementioned methods to discover and manage devices in the EMS 100. It should be understood that a more sophisticated computerized module is operable to be used. Furthermore, components may be added or removed from the computerized module 600 to provide the desired functionality.

The computerized system 600 includes one or more processors, such as processor 602, providing an execution platform for executing software. Thus, the computerized system 600 includes one or more single-core or multi-core processors of any of a number of computer processors, such as processors from Intel and AMD. As referred herein, a computer processor may be a general-purpose processor, such as a central processing unit (CPU) or any other multi-purpose processor or microprocessor. A computer processor also may be a special-purpose processor, such as a graphics processing unit (GPU), an audio processor, a digital signal processor, or another processor dedicated for one or more processing purposes. Commands and data from the processor 602 are communicated over a communication bus 604. The computerized system 600 also includes a main memory 606 where software is resident during runtime, and a secondary memory 608. The secondary memory 608 may also be a computer readable medium (CRM) that may be used to store the software programs, applications, or modules that implement the device plug-in package releases 140, and components therein, and EMS release 110, and components therein, and the methods describe in FIGS. 4 and 5. The main memory 606 and secondary memory 608 (and an optional removable storage unit 614) each includes, for example, a hard disk drive and/or a removable storage drive 612 representing a floppy diskette drive, a magnetic tape drive, a compact disk drive, etc., or a nonvolatile memory where a copy of the software may be stored. In one example, the secondary memory 608 also includes ROM (read only memory), EPROM (erasable, programmable ROM), EEPROM (electrically erasable, programmable ROM), or any other electronic, optical, magnetic, or other storage or transmission device capable of providing a processor or processing unit with computer-readable instructions. The computerized system 600 may include a display 620 connected via a display adapter 622 for providing users (such as EMS operators) with the aforementioned EMS GUI, user interfaces comprising a wireless interface for establishing wire connectivity with clients. A network interface 630 is also provided for communicating with networks of devices that the EMS 100 manages, such as a local area network (LAN), a wide area network (WAN), the Internet, or any other IP-based network.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for managing a device by a management system, comprising:
loading a plurality of device plug-in packages for managing a plurality of devices;
detecting a device in the management system;
identifying the detected device; and
employing one of the plurality of device plug-in packages to manage the detected device based at least on the identifying of the detected device, the employing includes,
constructing a device model for the detected device based on the one device plug-in package; and
managing the detected device by accessing the detected device through the device model.

2. The method of claim 1, wherein identifying the detected device comprises:
determining a type of the detected device.

3. The method of claim 2, wherein upon determining the type of the detected device is not known, generating a discovery failure event to indicate failure to identify the detected device.

4. The method of claim 2, wherein identifying the detected device further comprises:
upon determining the type of the device is known, determining whether there is a discovery plug-in in one of the plurality of plug-in packages that is operable to detect the model and firmware version of the detected device.

5. The method of claim 4, further comprising:
upon determining that there is no discovery plug-in that is operable to detect the model and firmware version of the detected device, generating a discovery failure event to indicate failure to identify the detected device.

6. The method of claim 4, wherein identifying the detected device further comprises:
upon determining that there is a discovery plug-in capable of detecting the model and firmware version of the detected device, using the capable discovery plug-in to identify the model and firmware version of the detected device.

7. The method of claim 6, further comprising:
updating a firmware map index to correspond the one employed device plug-in package to the type, model, and firmware version of the detected device.

8. The method of claim 1, wherein constructing the device model comprises:
requesting a device model instance of the detected device;
obtaining a list of at least one device plug-in in the one device plug-in package based on a look-up of the firmware map index;
loading up at least one device plug-in implementation corresponding to the at least one device plug-in in the list;
caching the at least one device plug-in implementation to create a device model implementation instance to implement the requested device model instance; and
accessing one or more functionalities of the detected device via the device model implementation instance.

9. The method of claim 8, wherein the one or more functionalities include at least one of fault management, configuration, accounting, performance, and security.

10. The method of claim 1, wherein the detected device is a component in a video headend system.

11. An element management system (EMS) for managing a network of devices, comprising:
a server core operable to handle operations common to all of the devices;
a server core interface operable to provide the devices with access to the server core for the common operations; and
a plurality of device plug-in package releases for accessing the devices, each of the plurality of device plug-in package releases includes at least one device plug-in interface and a corresponding device plug-in implementation;
wherein the at least one device plug-in interface is operable to provide the server core with access to the corresponding device plug-in implementation, and the corresponding device plug-in implementation is operable to provide access to at least one functionality of one of the devices.

12. The EMS of claim 11, wherein the at least one functionality of one of the devices includes at least one of discovery, fault management, configuration, accounting, performance, and security.

13. The EMS of claim 11, further comprising an EMS database operable to store a map index that categorizes the devices based on at least one of a device type, device model, and device firmware version.

14. The EMS of claim 11, wherein the server core comprises a plurality of modules, each operable to call up a corresponding one of the at least one device plug-in interface in each of the plurality of device plug-in package releases.

15. The EMS of claim 11, wherein the plurality of modules include at least some of:
a first module operable to read or write parameters for device identification to the devices (Configuration module);
a second module operable to retrieve device configuration parameters from the devices and to synchronize the retrieved device configuration parameters with information in an EMS database (ConfigSync module);
a third module operable to detect and identify at least one of a type, model, and firmware version of at least one of the devices (Discovery module);
a fourth module operable to synchronize alarm states in the devices with alarms in the EMS database (alarm synchronization);
a fifth module operable to implement the operations common to all of the devices (TrapProcessor module); and
a sixth module operable to periodically determine communication states of the devices (Statuspoller module).

16. A computer readable medium on which is encoded program code for managing a device by a management system, the program code comprising:
program code for loading a plurality of device plug-in packages for managing a plurality of devices;
program code for detecting a device in the management system;
program code for identifying the detected device; and
program code for employing one of the plurality of device plug-in packages to manage the detected device based at least on the identifying of the detected device, the program code for employing includes,
program code for constructing a device model for the detected device based on the one device plug-in package; and
program code for managing the detected device by accessing the detected device through the device model.

17. The computer readable medium of claim 16, wherein the program code for constructing the device model comprises:
program code for requesting a device model instance of the detected device;
program code for obtaining a list of at least one device plug-in in the one device plug-in package based on a look-up of the firmware map index;
program code for loading up at least one device plug-in implementation corresponding to the at least one device plug-in in the list;
program code for caching the at least one device plug-in implementation to create a device model implementation instance to implement the requested device model instance; and
program code for accessing one or more functionalities of the detected device via the device model implementation instance.

18. The computer readable medium of claim 16, wherein the program code for identifying the detected device comprises:
program code for determining a type of the detected device is known.
